(19) United States
(12) Patent Application Publication
(10) Pub. No.: US 2009/0190162 A1
(43) Pub. Date: Jul. 30, 2009

(54) Print control device, information display method for print control device, and information display program for print control device

(75) Inventors: Yuji Kohama, Sapporo-Shi (JP); Masahiko Hirasawa, Sapporo-Shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/319,645

(22) Filed: Jan. 9, 2009

(30) Foreign Application Priority Data
Jan. 9, 2008 (JP) 2008-001901
Nov. 13, 2008 (JP) 2008-290661

(51) Int. Cl. G06F 3/12

(52) U.S. Cl. 358/1.15

(57) ABSTRACT

A print control device that executes a plurality of filtering units sequentially and in parallel to generate print data of a document includes: an acquisition unit that acquires print information that at least includes attribute information related to the attribute of the document on which the filtering units are executed and status information that indicates a status in which the print data are generated, from the respective filtering units; and a display unit that displays information display areas for the filtering units, arranged in a predetermined direction in order of which filtering unit is executed first, and that displays the attribute information and status information of the print information in the information display area for each filtering unit.

### BACKGROUND

1. Technical Field

The invention relates to a print control device that controls printing by a printing apparatus, an information display method for a print control device, and an information display program for a print control device.

2. Related Art

When a program that runs on a computer executes a task that requires a certain period of time for processing, a progress bar is known as a tool that shows the progress of the processing to the user dynamically using a bar chart in regard to how many percentages the task is complete. JP-A-2001-134411 describes a printer driver that shows the progress of printing process in a printer to the user using a progress bar.

However, because the existing progress bar shows the progress of printing in the printer, the operating status of each function of the printer driver or the progress of each piece of attribute information, such as a page handled by each function in a document subjected to the printing process cannot be obtained from the printer driver.

### SUMMARY

An advantage of some aspects of the invention is that it provides a solution for at least portion of the above described problem, and the solution may be implemented as the following aspects or application examples.

### First Application Example

A first application example provides a print control device that executes a plurality of filtering units sequentially and in parallel to generate print data of a document. The print control device includes: an acquisition unit that acquires print information that at least includes attribute information related to the attribute of the document on which the filtering units are executed and status information that indicates a status in which the print data are generated, from the respective filtering units; and a display unit that displays information display areas for the filtering units, arranged in a predetermined direction in order of which filtering unit is executed first, and that displays the attribute information and status information of the print information in the information display area for each filtering unit.

With this configuration, the display unit of the print control device displays the information display areas for the filtering units, arranged in order of which filtering unit is executed first, and each information display area shows the attribute information of the document processed in the corresponding filtering unit and the status information that indicates the status in which print data are generated. Thus, it is possible to easily see the progress of generation of print data in each filtering unit and the attribute of the document processed in each filtering unit.

### Second Application Example

The print control device according to the above application example may further include an instruction unit that provides an instruction for controlling each of the filtering devices; and a control unit that controls the filtering units on the basis of the instruction provided from the instruction unit.

With this configuration, it is possible to control the filtering units on the basis of an instruction provided from the instruction unit.

### Third Application Example

In the print control device according to the above application example, the instruction unit may further provide an instruction for controlling the filtering units document by document.

With this configuration, it is possible to control the filtering units document by document.

### Fourth Application Example

In the print control device according to the above application example, the attribute information may include identification information of the corresponding document and page information of the corresponding document, and the display unit may display the identification information and page information of each of the documents, processed in the respective filtering units, in the information display area for a corresponding one of the filtering units.

With this configuration, it is possible to see the identification information and page information of each of the documents processed in the respective filtering units.

### Fifth Application Example

In the print control device according to the above application example, the display unit may display the ratio of a processed amount to an amount to be processed in each filtering unit with a progress bar.

With this configuration, it is possible to display the ratio of progress of the process in each filtering unit.

### Sixth Alternative Example

In the print control device according to the above application example, the display unit may display images of the pieces of print data that are sequentially generated in the respective filtering units.

With this configuration, it is possible to display an image of the progress of the process in each filtering unit.

### Seventh Application Example

In the print control device according to the above application example, the print information acquired by the acquisition unit may be held, and the display unit may compare print information acquired subsequently with the held print information and, when the two pieces of print information are different, may perform display on the basis of the print information acquired by the acquisition unit.

With this configuration, it is possible to effectively display print information.

### Eighth Application Example

An eighth application example provides an information display method for a print control device that executes a plurality of filtering units sequentially and in parallel to generate print data of a document. The print control method includes: acquiring print information that at least includes attribute information related to the attribute of the document on which the filtering units are executed and status information that indicates a status in which the print data are generated, from the respective filtering units; and displaying information display areas for the filtering units, arranged in a predetermined direction in order of which filtering unit is executed first, and displaying the attribute information and status information of the print information in the information display area for each filtering unit.

With this method, the information display areas for the filtering units are displayed so that they are arranged in order of which filtering unit is executed first, and each information display area shows the attribute information of the document processed in the corresponding filtering unit and the status information that indicates the status in which print data are generated. Thus, it is possible to easily see the progress of generation of print data in each filtering unit and the attribute of the document processed in each filtering unit.

### Ninth Application Example

A ninth application example provides a computer-readable storage medium storing an information display program, executable on a computer, for a print control device that executes a plurality of filtering units sequentially and in parallel to generate print data of a document. The print control program includes instructions for: acquiring print information that at least includes attribute information related to the attribute of the document on which the filtering units are executed and status information that indicates a status in which the print data are generated, from the respective filtering units; and displaying information display areas for the filtering units, arranged in a predetermined direction in order of which filtering unit is executed first, and displaying the attribute information and status information of the print information in the information display area for each filtering unit.

With this program, the information display areas for the filtering units are displayed so that they are arranged in order of which filtering unit is executed first, and each information display area shows the attribute information of the document processed in the corresponding filtering unit and the status information that indicates the status in which print data are generated. Thus, it is possible to easily see the progress of generation of print data in each filtering unit and the attribute of the document processed in each filtering unit.

### BRIEF DESCRIPTION OF THE DRAWINGS

The invention will be described with reference to the accompanying drawings, wherein like numbers reference like elements.

FIG. 1 is a block diagram that illustrates the functional configuration of a printer driver according to an embodiment.

FIG. 2 is a view that shows an example of a print information display window.

FIG. 3 is a view that shows an example of a screen for setting layout printing.

FIG. 4 is a view that shows an example of a screen for displaying an image during filtering.

FIG. 5 is a flowchart that shows the flow of a print information display process.

FIG. 6 is a flowchart of filtering.

FIG. 7 is a flowchart of filtering.

FIG. 8 is a flowchart of filtering.

### DESCRIPTION OF EXEMPLARY EMBODIMENTS

Hereinafter, a printer driver, which is an embodiment of a print control device, will be described with reference to the accompanying drawings.

### Embodiment

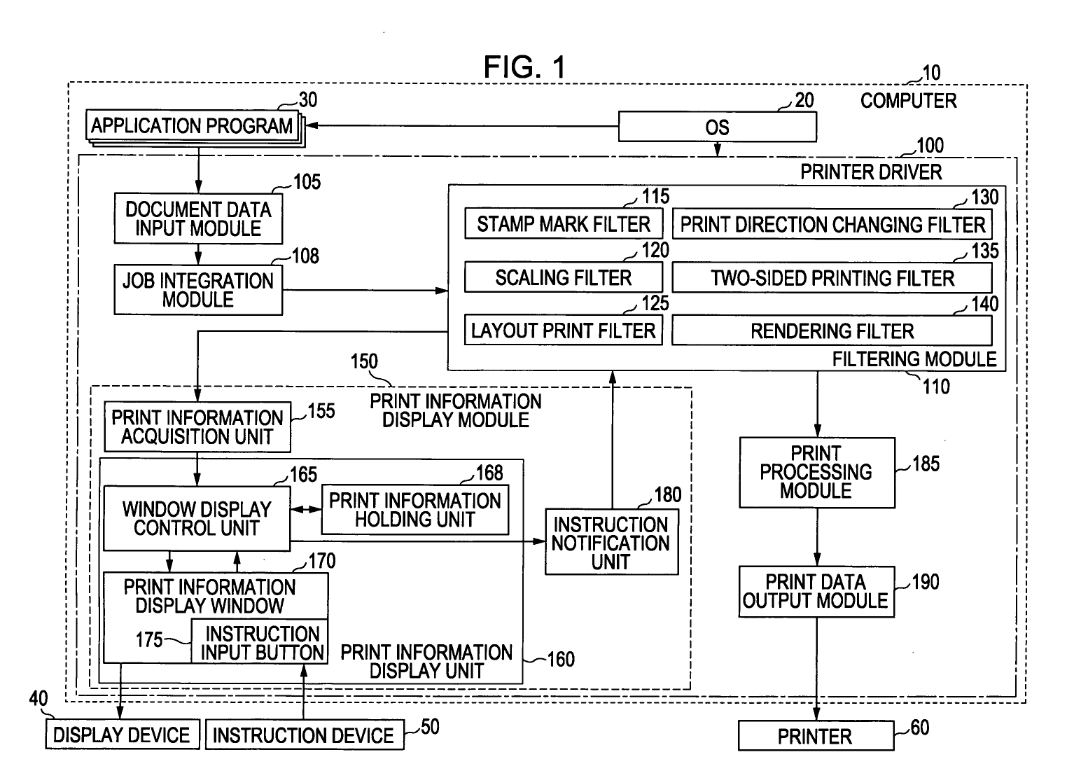

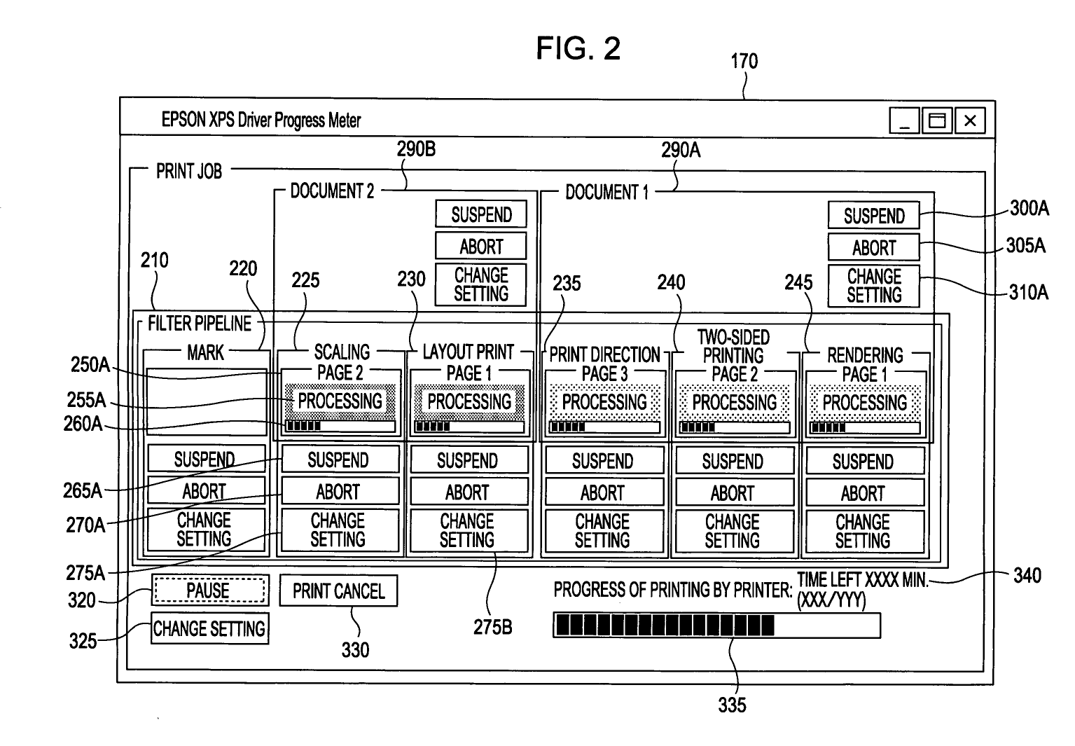

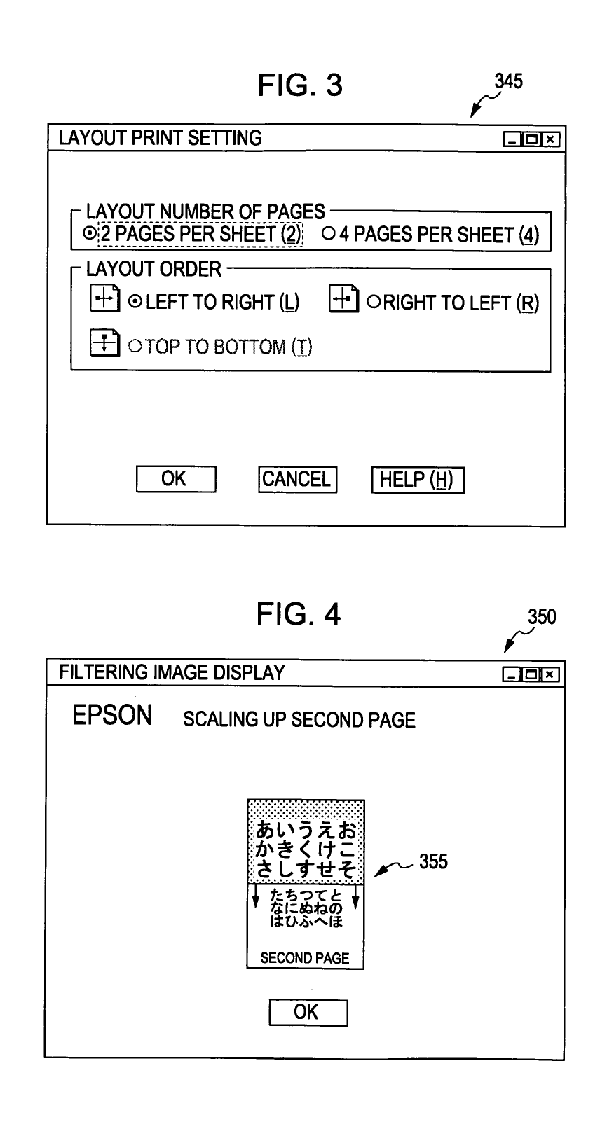

FIG. 1 is a block diagram that illustrates the functional configuration of a printer driver 100 that controls a printer 60 for printing. The printer driver 100 is installed on a computer 10, and includes a document data input module 105, a job integration module 108, a filtering module 110, a print information display module 150, a print processing module 185 and a print data output module 190. Note that the printer driver 100 not only has the function of handling one document for printing but also may have the function of, as in a virtual driver of an XPS (XML Paper Specification) that is an electronic document based on XML (eXtensible Markup Language), collectively handling a plurality of documents for printing. Note that FIG. 2, FIG. 3 and FIG. 4 will be referred to as needed for describing the functions and operations of the printer driver 100.

First, the outline of the computer 10 on which the printer driver 100 is installed will be described. The computer 10 includes a CPU (Central Processing Unit), a RAM (Random Access Memory), a ROM (Read Only Memory), an external storage device, and the like, which are not shown in the drawing, and the functions are controlled by a predetermined OS (Operating System) 20. In addition, the computer 10 is connected to the printer 60, a display device 40 such as a liquid crystal display panel, and an instruction device 50 such as a mouse, through predetermined interfaces. The CPU loads various programs, such as basic software and application software, and various pieces of data from the ROM or the external storage device, and expands them in a main memory area provided in the RAM for execution. Note that the modules of the printer driver 100 implement functions, which will be described later, by organic cooperation of hardware resources formed of the CPU, the RAM, and the like, with various pieces of software included in the printer driver 100.

The computer 10 has a plurality of installed application programs 30 having a print instruction function. These application programs 30 are able to create documents on the respective application programs 30 on the basis of an instruction from the user, and are able to transmit respective pieces of edited document data to the printer driver 100. The printer driver 100 conforms to XPS format, so the printer driver 100 is able to handle the respective pieces of document data as one integrated print job.

The document data input module 105 transmits documents, transmitted from the respective application programs 30, to the job integration module 108. The job integration module 108 integrates these plurality of documents into one print job, and transmits the print job to the filtering module 110. The filtering module 110 includes a stamp mark filter 115, a scaling filter 120, a layout print filter 125, a print direction changing filter 130, a two-sided printing filter 135 and a rendering filter 140, which are pipeline-connected to one another. The stamp mark filter 115 has the function of automatically printing “confidential” mark or a selected image or character on a printed matter (the size, color, or position of the mark is changeable). This filter is not limited to drawing an image on a front surface, but the filter is able to draw an image on a back surface or draw a water mark depending on the print content. The scaling filter 120 has the function of scaling the print content in a selected scaling factor for printing (the offset of a printed image is also changeable). Furthermore, the scaling filter 120 also has the function of automatically calculating an enlargement factor in accordance with a paper size (fit page) for printing.

The layout print filter 125 has the function of arranging print data of multiple pages in one page by reducing the size of the print data or changing the orientation of an image. In addition, the layout print filter 125 is able to change the layout of pages at the time of arrangement and is also able to print a frame border, or the like. The print direction changing filter 130 has the function of switching the orientation of an image between portrait and landscape. The two-sided printing filter 135 has the function of sorting the page order in the order of odd-numbered page and even-numbered page when two-sided printing is performed manually. The rendering filter 140 has the function of rendering print data to create raster data transmitted to the printer 60. The filtering module 110 executes processes of the above described filters sequentially and in parallel page by page for each of the plurality of documents included in the print job to create a print command described in printer description language that can be interpreted by the printer 60 for each filtering, and transmits the print commands to the print processing module 185. The print processing module 185 generates print data for each document by sorting the generated print commands in a predetermined order, and then the generated pieces of print data are output from the print data output module 190. The printer 60 sequentially inputs the pieces of print data and then sequentially print documents on the basis of the input print data.

The print information display module 150 includes a print information acquisition unit 155, a print information display unit 160 and an instruction notification unit 180. When print data are generated in each filtering, the print information display module 150 displays the pieces of status information of the respective filters of the filtering module 110 and the pieces of attribute information of documents processed in the respective filters of the filtering module 110. The print information acquisition unit 155 acquires print information that at least includes the attribute information related to the attributes of processing target documents in the filtering module 110 and the status information that indicates the status in which print data are generated, from the filters 115 to 140 of the filtering module 110. In the present embodiment, the attribute information includes the identification symbol of a document and the page number of a document, and the status information includes a status related to the percentage of progress of a process and execution of a process. In addition, the print information may be exchanged through a predetermined memory area that is accessible by both the filtering module 110 and the print information acquisition unit 155, or may be exchanged through communications in a message form between the filtering module 110 and the print information display module 150. The print information acquisition unit 155 acquires print information at predetermined time intervals and transmits the acquired print information to the print information display unit 160.

The print information display unit 160 includes a window display control unit 165, a print information holding unit 168, and a print information display window 170. The print information display unit 160 displays the information display areas for the filters 115 to 140, arranged in a predetermined direction in order of which filters 115 to 140 of the filtering module 110 are executed first, and displays the attribute information and status information of the print information acquired from the filtering module 110 in the information display area for each of the filters 115 to 140. In the present embodiment, the print information display window 170 is displayed on the display device 40 in accordance with a control by the window display control unit 165. At this time, the print information holding unit 168 still holds the print information that is previously transmitted from the print information acquisition unit 155. The window display control unit 165 compares the print information transmitted from the print information acquisition unit 155 with the print information held by the print information holding unit 168, and, when the pieces of print information are different, instructs the print information display window 170 to update display. In addition, the print information display window 170 has instruction input buttons 175 for providing instructions for controlling the respective processes in the filters 115 to 140 of the filtering module 110. The instruction input buttons 175 are specified by the user through the instruction device 50, and the specified information is detected by the window display control unit 165 and transmitted to the instruction notification unit 180. The instruction notification unit 180 operates as a controller that controls the processes of the filtering module 110 corresponding to the instruction input buttons 175 on the basis of an instruction from the user. That is, the instruction notification unit 180 notifies the corresponding filter of the filtering module 110 of the specified information, and the notified filter is controlled in accordance with the notified instruction.

FIG. 2 shows “XPS Driver Progress Meter”, which is an example of the print information display window 170. The “XPS Driver Progress Meter” displays information display areas 220 to 245 for the respective filters 115 to 140 in a filter pipeline display area 210 horizontally from left to right in order of which filters 115 to 140 are executed first. That is, from the left side, a stamp mark filter information display area 220, a scaling filter information display area 225, a layout print filter information display area 230, a print direction changing filter information display area 235, a two-sided printing filter information display area 240 and a rendering filter information display area 245 are displayed. When the filters 115 to 140 corresponding to the respective information display areas 220 to 245 are in process, the page number 250, process status information 255 and process progress information 260 of the in-process document are displayed in the corresponding information display areas 220 to 245 from top to bottom. In the present embodiment, the process progress information 260 is displayed with a progress bar. In addition, as in the case of the stamp mark filter information display area 220, when the above pieces of information are not displayed, it indicates that the process ends. In addition, whether a document is processed by the filters 115 to 140 is set document by document in a property screen (not shown) of the printer driver 100 before printing process. Note that in the following description, the scaling filter information display area 225 will be illustrated and described as a typical display area.

Document display areas 290A and 290B are dynamically displayed while being superimposed on the page number 250A, process status information 255A and process progress information 260A of the scaling filter information display area 225. That is, two document display areas 290A and 290B being processed in the filters 115 to 140 of the filtering module 110 respectively have “Document1” and “Document2” as document identification symbols. One document display area 290A is such that the first page is in process of rendering, the second page is in process of two-sided printing processing, and the third page is in process of print direction changing. In addition, the other document display area 290B is such that the first page is in process of layout print processing, and the second page is in process of scaling. In this case, the background and/or characters of the page number 250, the process status information 255, the process progress information 260, or the like, may be color-coded document by document. The document display areas 290A and 290B initially appear at the left side, sequentially move to the right side in accordance with completion of the processes of the filters 115 to 140, and finally disappear when all the processes are complete. In addition, a suspend button 265A, an abort button 270A and a change setting button 275A are respectively displayed at the bottom of the scaling filter information display area 225. These are the above described instruction input buttons 175, and the same buttons 300A to 310A are respectively displayed at the upper right in the document display areas 290A and 290B.

The suspend button 265A displayed in the scaling filter information display area 225 temporarily suspends the process of the scaling filter 120 corresponding to the scaling filter information display area 225 to which the suspend button 265A belongs. In this case, the other processes are not suspended; however, the data of the second page of the temporarily suspended document display area 290B do not proceed to the next process, so eventually the process of the suspended document display area 290B is all temporarily suspended. On the other hand, the suspend button 300A displayed in the document display area 290A temporarily suspends the processes of all the filters, that is, the processes of the print direction changing filter 130, two-sided printing filter 135 and rendering filter 140, in which the document display area 290A to which the suspend button 300A belongs is processed. In addition, although not shown in the drawing, the display of the pressed suspend button 265A is changed to “resume process”, and the suspended process is resumed by pressing the button again. The abort button 270A displayed in the scaling filter information display area 225 aborts the process of the scaling filter 120 corresponding to the scaling filter information display area 225 to which the abort button 270A belongs. In this case, only for the second page of the in-process document display area 290B, printing process is cancelled; however, all printing process for the cancelled page and pages following the cancelled page may be cancelled instead. On the other hand, for the abort button 305A displayed in the document display area 290A, printing process of the document display area 290A to which the abort button 305A belongs is cancelled. That is, the suspend button 265A provides an instruction for suspending the processes for the in-process page and pages following the in-process page. On the other hand, the abort button 270A provides an instruction for canceling printing of the in-process page and maintaining the processes for pages following the in-process page.

The change setting button 275A displayed in the scaling filter information display area 225 displays a change setting dialog of the scaling filter 120 corresponding to the scaling filter information display area 225 to which the change setting button 275A belongs, and allows dynamic change of print settings page by page. For example, when the change setting button 275B of the layout print filter 125 is pressed, a layout print setting dialog 345, as shown in FIG. 3, appears. On the other hand, the change setting button 310A displayed in the document display area 290A sequentially displays change setting dialogs of the print direction changing filter 130, two-sided printing filter 135 and rendering filter 140 of the document display area 290A to which the change setting button 310A belongs, and allows dynamic change of print settings page by page. In addition, in the present embodiment, when the process status information 255A is “processing”, by clicking on the area of the process status information 255A with a mouse, a filtering image display window 350 that dynamically displays a processed image 355 that is being processed by the scaling filter 120 is displayed as shown in FIG. 4. In addition, in place of displaying the process progress information 260 with a progress bar, the processed image 355 may be dynamically displayed. In addition, the “XPS Driver Progress Meter” provides a pause button 320, a change setting button 325 and a print cancel button 330 for controlling the printer 60, a time display area 340 and a progress bar 335 that respectively display numerals and accumulation of block areas for time left until completion of printing for displaying the progress of printing by the printer 60.

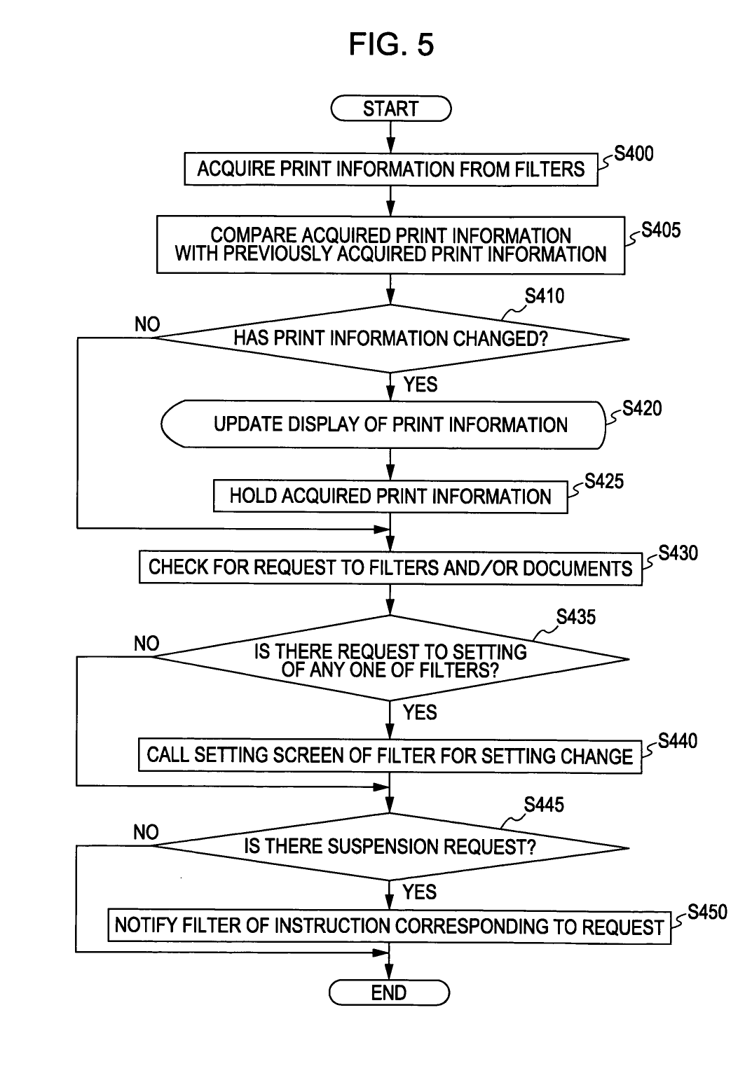

FIG. 5 is a flowchart that shows the flow of a print information display process in which print information is displayed by the print information display module 150. The flow of the process will be described with reference to FIG. 5. Note that in the present embodiment, the print information display process is called at predetermined time intervals when the printer driver 100 executes a printing process. First, the CPU acquires print information from the filters 115 to 140 of the filtering module 110 (step S400). Then, the CPU compares the acquired print information with the previously acquired and held print information (step S405). Subsequently, the CPU determines whether the print information is changed from the previous print information (step S410). Here, when it is determined that the print information is not changed (No in step S410), the process proceeds to step S430. On the other hand, when it is determined that the print information is changed (Yes in step S410), the CPU updates the display of the print information (step S420), and holds the currently acquired print information (step S425). Next, in step S430, the CPU checks whether there is a request to the filters 115 to 140 of the filtering module 110 from the user. Here, when the CPU determines that there is a setting request to any one of the filters (Yes in step S435), the CPU calls a setting screen of the corresponding filter to change settings (step S440) and then proceeds to step S445. On the other hand, when the CPU determines that there is no setting request to any one of the filters (No in step S435), the process directly proceeds to step S445.

After that, in step S445, the CPU checks whether there is a suspension request, including suspension and resumption of the process, from the user. Here, when the CPU determines that there is a suspension request for the process (Yes in step S445), the CPU notifies the corresponding filter of an instruction according to the request (step S450), and then ends the series of processes. On the other hand, when the CPU determines that there is no suspension request for the process (No in step S445), the CPU ends the series of processes. With the above described print information display module 150, the user is able to easily check the progress information of a printing process being processed in the printer driver 100 and the page information of each document, and is also able to instruct the printer driver 100 to suspend and resume a printing process document by document, page by page, and process by process of the filters. Furthermore, the user is able to change print settings even during printing process and is able to continue the printing process on the basis of the changed print settings.

The embodiment of the invention is described with reference to the accompanying drawings; however, the aspects of the invention are not limited to the present embodiment. The aspects of the invention may encompass the following alternative embodiments.

(1) The filtering module 110 not only includes the above described filters 115 to 140 but also may include the following filters.
Poster printing filter: This filter has the function of creating a large-sized poster by using a plurality of pieces of certain size paper. Specifically, one piece of image data is divided into desired multiple pieces, a starching overlap width, and the like, is added to each page, and then the multiple pieces of image data are allocated.
180-degree rotation filter: This filter has the function of rotating the orientation of an image by 180 degrees.
Borderless printing filter: This filter has the function of implementing borderless printing. Specifically, the enlargement factor is calculated in accordance with run-off level and then an original image is enlarged. In addition, an offset is adjusted.
Booklet filter: This filter has the function of creating a booklet. Specifically, the order of arrangement of pages is changed, and then layout printing and print direction changing are performed.
Inverse order printing filter: This filter has the function of sorting the order of pages of a printed matter in the order from the last page to the first page.
Flip horizontal/flip vertical filter: This filter has the function of flipping a printed image horizontally or vertically.
Multiple copy/collation printing filter: This filter has the function of printing multiple copies.
Color correction/image correction filter: This filter has the function of implementing color correction, such as auto photo fine or color matching, and image correction, such as web smoothing (character outline correction) or red-eye correction.

Automatic color/monochrome switching filter: This filter has the function of checking print data, printing an image in monochrome in the case of a monochrome image, and switching to color printing in the case of a color image. Roll sheet tear-off line printing filter: This filter has the function of printing a tear-off line/closing line on a roll sheet.

Roll sheet automatic image rotation filter: This filter has the function of switching the printing direction of an image depending on the width of a roll sheet in roll sheet printing.
Print information adding filter: This filter has the function of automatically additionally printing a printing user, printed data and time, a header/footer, and various pieces of log information.
Print output data compression filter: This filter has the function of automatically compressing print data transmitted to the printer 60.
Print output data encryption filter: This filter has the function of automatically encrypting print data transmitted to the printer 60.
(2) The print information display window 170 is not limited to the “XPS Driver Progress Meter” shown in FIG. 2. For example, it may be formed of only the filter pipeline display area 210, and, in addition, the suspend button 265, the abort button 270 and the change setting button 275 may be omitted, and the process status information 255 and the process progress information 260 may be displayed in text form. In addition, when a plurality of pages are temporarily stored and then rearranged into one page as in the case of layout printing, or the like, or when one page is rearranged into a plurality of pages, temporarily stored information may be indicated so that “Pages 1 to 4” is displayed at the page number 250 and “spooling” is displayed at the process status information 255. In addition, the positions of the buttons 300, 305 and 310 displayed in each document display area 290 may be fixed and arrows, or the like, may be moved in place of moving the buttons 300, 305 and 310 in accordance with a shift in document.
(3) When the process of a selected page is temporarily suspended, the process of pages following the temporarily suspended page may be continued. That is, a print control device that generates print data of a document including a plurality of pages by sequentially processing the pages of the document using a plurality of filtering devices may include a temporarily suspended page accepting device that accepts specification of a temporarily suspended page on which the plurality of filtering devices temporarily suspend processes; and a filtering control device that, when accepting the specification of the temporarily suspended page, suspends the processes by the plurality of filtering devices for the temporarily suspended page and maintains processes by the plurality of filtering devices for the pages other than the temporarily suspended page. With the above configuration, a selected page may be temporarily suspended, and the processes for the other pages may be preceded.

In addition, the filtering control device may accept an instruction for temporarily suspending a process for a page that is in process of any one of the plurality of filtering devices. With this configuration, data indicating a page before being processed by the filtering device are saved for the page for which the temporary suspension instruction is accepted, and pages other than the temporarily suspended page are continued to be processed by the filtering devices. Then, filtering is executed with reference to the saved data at a predetermined timing at which the process for the temporarily suspended page should be resumed. With this configuration, the process of a selected filtering device among the plurality of filtering devices may be temporarily suspended. Note that the predetermined timing may be a timing at which instruction for resuming the process of temporarily suspended page is accepted or may be a timing after the process related to the last page in the document ends.

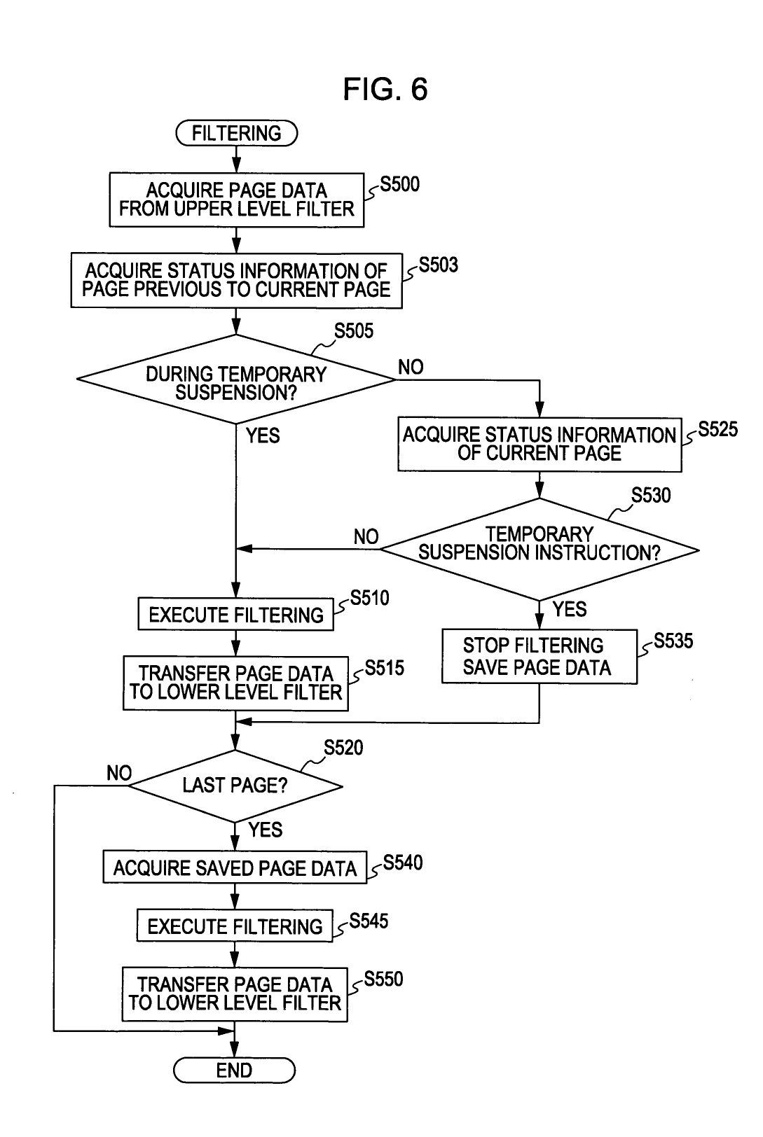

More specifically, for example, it may be implemented by adding the configuration that executes the process shown in FIG. 6 to the configuration substantially similar to the embodiment shown in FIG. 1. That is, the plurality of filtering devices and the filtering control device are formed of the stamp mark filter 115 to the rendering filter 140 shown in FIG. 1. In addition, the print information display module 150 shown in FIG. 1 forms the temporarily suspended page accepting device, and the suspend button 265A, and the like, of the print information display window 170 shown in FIG. 1 and FIG. 2 accepts specification of a temporarily suspended page.

Then, the stamp mark filter 115 to the rendering filter 140 execute the process shown in FIG. 6. FIG. 6 illustrates the process related to temporary suspension of a page in each filter, and illustrates the previously executed filter as an upper level filter. In this process, the CPU receives page data from the upper level filter (step S500). That is, in the stamp mark filter 115 to the rendering filter 140, it is determined that the process of a filter having a smaller reference numeral is executed first, and in the present embodiment, each filter sequentially acquires page data on which the process of the upper level filter has been executed. Note that because there is no upper level filter for the stamp mark filter 115, the stamp mark filter 115 acquires page data from the job integration module 108. In addition, here, a page indicated by the page data acquired in step S500 is referred to as a current page.

Next, the CPU acquires the status information of a page previous to the current page (step S503), and determines whether the page previous to the current page is already temporarily suspended (step S505). That is, when a temporary suspension instruction is provided for a selected page, the status information includes information that indicates that the selected page is temporarily suspended. Thus, the CPU determines whether the page previous to the current page is temporarily suspended by referring to the status information related to the page previous to the current page.

When it is determined that the page previous to the current page is temporarily suspended in step S505, in the present embodiment, filtering is continued for the other pages without temporary suspension. For this reason, the CPU executes filtering on the current page (step S510). Then, after filtering the current page, the CPU transfers the page data to the lower level filter (step S515). Note that because there is no lower level filter for the rendering filter 140, the rendering filter 140 transfers the page data to the print processing module 185.

On the other hand, when it is not determined that the page previous to the current page is temporarily suspended in step S505, the CPU acquires the status information of the current page (step S525), and determines whether a temporary suspension instruction is provided for the current page (step S530). That is, when the suspend button 265A, and the like, of the print information display window 170 is operated, the temporary suspension instruction is written to the status information of the current page. Thus, the CPU refers to the status information of the current page to determine whether the current page corresponding to the page data acquired in step S500 is temporarily suspended.

In step S530, when it is not determined that a temporary suspension instruction is provided for the current page, the process in step S510 and the following processes are executed. In step S530, when it is determined that a temporary suspension instruction is provided for the current page, the CPU stops filtering related to the current page and saves the page data before application of filtering in the external storage device, or the like (step S535), and then executes the process in step S520 and the following processes.

After step S515 and step S535, it is determined whether the current page is the last page of the document (step S520). In step S520, it is determined that the current page is the last page of the document, the CPU acquires the page data saved in step S535 (step S540), executes filtering on the acquired page data, and then transfers the filtered page data to the lower level filter (step S545 and step S550).

By sequentially executing the above processes on each page, temporary suspension of filtering for a selected page is allowed, and, after filtering is temporarily suspended, filtering on the pages following the temporarily suspended page are preceded. In addition, after filtering is temporarily suspended, when the last page of the document including the temporarily suspended page has been processed, filtering on the temporarily suspended page is resumed. Thus, by temporarily suspending the process for a selected page, it is possible to print a desired page at the end of the document.

Note that in the above described embodiment, when a specific filtering is temporarily suspended for a page, the specific filtering cannot be temporarily suspended for another page; instead, it may be configured so that when a specific filtering is temporarily suspended for a page, the specific filtering may also be temporarily suspended for another page. Furthermore, in the above described embodiment, after filtering is temporarily suspended, and when the current page is the last page, the process for the temporarily suspended page is resumed; instead, filtering may be resumed at a selected timing (for example, it is configured so that a resumption instruction is accepted through the “resume process” button after pressing the above suspend button 265A, and the like, and when a resume instruction is accepted through the “resume process” button).

(4) It may be configured so that when the process for a selected document is temporarily suspended, the processes for documents following the temporarily suspended document is continued. That is, a print control device that generates print data for a plurality of documents by sequentially processing pages of each document using a plurality of filtering devices may include a temporarily suspended document accepting device that accepts specification of a temporarily suspended document on which the plurality of filtering devices temporarily suspend processes; and a filtering control device that, when accepting the specification of the temporarily suspended document, suspends the processes by the plurality of filtering devices for the temporarily suspended document, and that continues processes by the plurality of filtering devices for documents other than the temporarily suspended document. With the above configuration, a selected document may be temporarily suspended, and the process for the other documents may be preceded.

In addition, the filtering control device may accept an instruction for temporarily suspending a process for a document that is in process of any one of the plurality of filtering devices. With this configuration, data before filtering are saved, and the processes by the filtering devices are continued for documents other than the temporarily suspended document. Then, filtering is executed with reference to the saved data at a predetermined timing at which the process for the temporarily suspended document should be resumed. With this configuration, the process of a selected filtering device among the plurality of filtering devices may be temporarily suspended. Note that the predetermined timing may be a timing at which an instruction for resuming the process for the temporarily suspended page is accepted or may be a timing after the process related to the last page in the document ends.

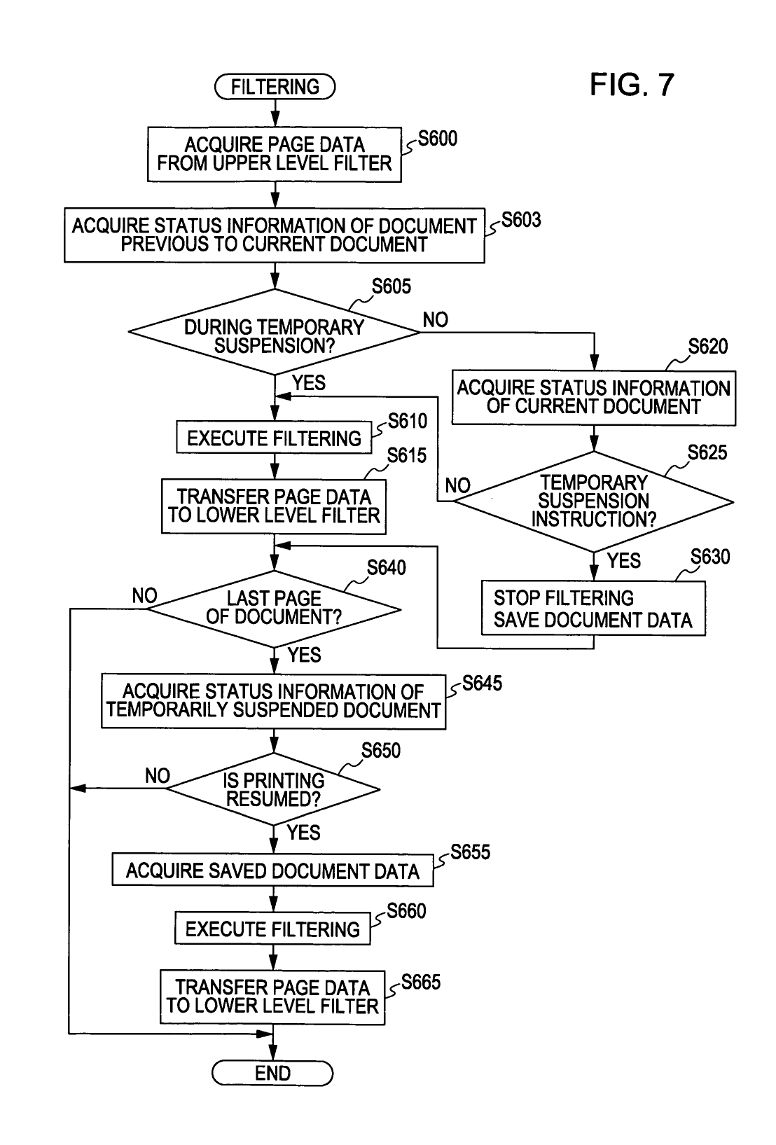

More specifically, for example, it may be implemented by adding the configuration that executes the process shown in FIG. 7 to the configuration substantially similar to the embodiment shown in FIG. 1. That is, the plurality of filtering devices, the filtering control device and the filtering resumption control device are formed of the stamp mark filter 115 to the rendering filter 140 shown in FIG. 1. In addition, the print information display module 150 shown in FIG. 1 forms the temporarily suspended document accepting device, the suspend button 300A, and the like, of the print information display window 170 shown in FIG. 1 and FIG. 2 accepts specification of a temporarily suspended document, and a resume instruction is accepted through the “resume process” button after the suspend button 300A is pressed.

Then, the stamp mark filter 115 to the rendering filter 140 execute the process shown in FIG. 7. Here, the previously executed filter is illustrated as an upper level filter. In this process, the CPU receives page data from the upper level filter (step S600). That is, in the stamp mark filter 115 to the rendering filter 140, it is determined that the process of a filter having a smaller reference numeral is executed first, and in the present embodiment, each filter sequentially acquires page data on which the process of the upper level filter has been executed. Note that because there is no upper level filter for the stamp mark filter 115, the stamp mark filter 115 acquires page data from the job integration module 108. In addition, here, a page indicated by the acquired page data is referred to as a current page, and a document including the current page is referred to as a current document.

Next, the CPU acquires the status information of a document previous to the current document (step S603), and determines whether the document previous to the current document is already temporarily suspended (step S605). That is, when a temporary suspension instruction is provided for a selected document, the status information includes information that indicates that the selected document is temporarily suspended. Thus, the CPU determines whether the document previous to the current document is temporarily suspended by referring to the status information related to the document previous to the current document.

When it is determined that the document previous to the current document is temporarily suspended in step S605, in the present embodiment, the filtering is continued for the other documents without temporary suspension. For this reason, the CPU executes filtering on the current page (step S610). Then, after filtering the current page, the CPU transfers the page data to the lower level filter (step S615). Note that because there is no lower level filter for the rendering filter 140, the rendering filter 140 transfers the page data to the print processing module 185.

On the other hand, when it is not determined that the document previous to the current document is temporarily suspended in step S605, the CPU acquires the status information of the current document (step S620), and determines whether a temporary suspension instruction is provided for the current document (step S625). That is, when the suspend button 300A, and the like, of the print information display window 170 is operated, the temporary suspension instruction is written to the status information of the current document. Thus, the CPU refers to the status information of the current document to determine whether the current document including the current page corresponding to the page data acquired in step S600 is temporarily suspended.

In step S625, when it is not determined that a temporary suspension instruction is provided for the current document, the process in step S610 and the following processes are executed in order to continue the process for the current page. On the other hand, in step S625, when it is determined that a temporary suspension instruction is provided for the current document, the CPU stops filtering related to the current document and saves the document data before application of filtering (all page data of the document including the current page) in the external storage device, or the like (step S630), and executes the process in step S640 and the following processes. That is, even when pages following the current page are included in the current document, filtering is stopped for all pages of the current document including the current page.

After step S610 and step S630, it is determined whether the current page is the last page of the current document (step S640). In step S640, when it is not determined that the current page is the last page of the current document, the CPU skips the processes in step S645 to step S665.

On the other hand, in step S640, when it is determined that the current page is the last page of the current document, the CPU acquires the status information of the temporarily suspended document (step S645), and determines whether printing is resumed (step S650). That is, it is determined whether a resume instruction is accepted through the “resume process” button after the suspend button 300A, and the like, is pressed.

In step S650, when it is not determined that printing is resumed, the CPU skips step S655 to step S665. In addition, when the status information of the temporarily suspended document cannot be acquired in step S645 (that is, not temporarily suspended), it is not determined in step S650 that printing is resumed.

In step S650, when it is determined that printing is resumed, the CPU acquires the saved document data (document data saved in S630) (step S655), and executes filtering on the acquired document data (step S660). Then, the CPU transfers the filtered document data to the lower level filter (step S665). That is, filtering is executed on all pages included in the temporarily suspended document, and the filtered data are transferred to the lower level filter.

By sequentially executing the above processes on each page, temporary suspension of filtering for a selected document is allowed, and, after filtering is temporarily suspended, filtering on documents following the temporarily suspended document is preceded. In addition, when the process for the last page of the selected document is performed after filtering is temporarily suspended, it is determined whether a resume instruction is provided for the temporarily suspended document. When the resume instruction is provided, filtering is resumed on the temporarily suspended document. Thus, it is possible to resume printing the temporarily suspended document at a desired timing. Note that in the above described embodiment, when filtering is temporarily suspended for a document, the filtering cannot be temporarily suspended for another document; instead, it may be configured so that when filtering is temporarily suspended for a document, the filtering may be temporarily suspended for another document.

(5) It may be configured so that setting change for a selected page may be executed. That is, a print control device that generates print data of a document including a plurality of pages by sequentially processing the pages of the document using a plurality of filtering devices may include a page data saving device that saves page data that indicate the pages before processes are performed by the plurality of filtering devices in a predetermined storage medium; a setting change accepting device that accepts a change of settings when the processes are performed by the plurality of filtering devices; and a filtering control device that, when accepting the change of settings, applies the changed settings to the saved page data to execute the processes using the plurality of filtering devices. With the above configuration, it is possible to execute filtering by changing settings of a selected page.

In addition, the filtering control device may accept setting change of a process for a page that is processed in any one of the plurality of filtering devices. With this configuration, the page data before the processes are performed by the filtering devices are saved, and filtering is executed again on the page, for which a setting change instruction is accepted, in order to apply the changed settings. With this configuration, it is possible to change settings of a selected page in a selected filtering of any one of the plurality of filtering devices.

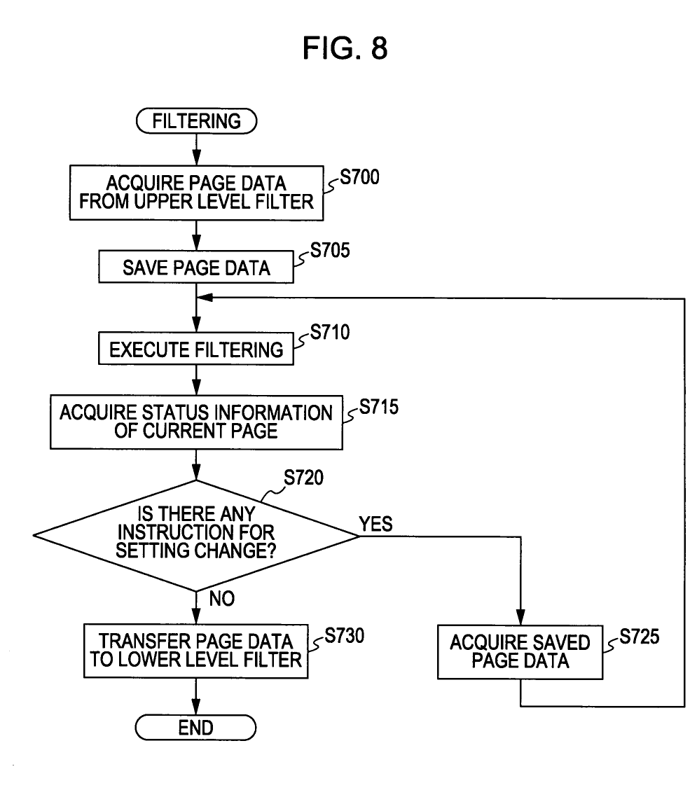

More specifically, for example, it may be implemented by adding the configuration that executes the process shown in FIG. 8 to the configuration substantially similar to the embodiment shown in FIG. 1. That is, the plurality of filtering devices, the page data saving device and the filtering control device are formed of the stamp mark filter 115 to the rendering filter 140 shown in FIG. 1. In addition, the print information display module 150 shown in FIG. 1 forms the setting change accepting device, and the change setting button 275A, and the like, of the print information display window 170 shown in FIG. 1 and FIG. 2 accepts specification of a setting change target filtering and a setting change target page.

Then, the stamp mark filter 115 to the rendering filter 140 execute the process shown in FIG. 8. FIG. 8 illustrates the process related to setting change of a page in each filter, and also illustrates the previously executed filter as an upper level filter. In this process, the CPU receives page data from the upper level filter (step S700). Note that because there is no upper level filter for the stamp mark filter 115, the stamp mark filter 115 acquires page data from the job integration module 108. In addition, here, a page indicated by the acquired page data is referred to as a current page.

Next, the CPU saves page data before application of filtering to the current page in the external storage device, or the like (step S705), and executes filtering on the current page (step S710). Furthermore, the CPU acquires the status information of the current page (step S715), and determines whether a setting change instruction is provided for the current page, on the basis of the status information (step S720).

In step S720, when it is determined that a setting change instruction is provided, the CPU acquires the page data saved in step S705 (step S725), and applies the changed settings to the acquired page data and then repeats the process in step S710 and the following processes again. That is, each filtering device is used for applying print settings, such as stamp mark, during printing, and each piece of page data includes data that indicate the settings, so each filtering device executes filtering by referring to the data that indicate the settings.

However, when a setting change instruction is provided through the change setting button 275A, and the like, in process of executing filtering in each filtering device, data that indicate the instructed settings are created, and filtering is executed again by referring to the data that indicate the created settings. Thus, it is possible to change settings of a selected filtering device for a selected page to desired settings.

On the other hand, in step S720, when it is not determined that a setting change instruction is provided (when a setting change instruction is not provided or when a setting change instruction is provided, filtering according to the setting change instruction is performed, and then another setting change instruction is not provided), the CPU transfers the filtered page data to the lower level filter (step S730).

Note that in the above embodiment, print settings may be changed page by page; instead, setting change may be accepted document by document or setting change may be accepted filtering by filtering. Thus, setting change may be employed in various configurations. In addition, an embodiment may be formed of a combination of temporary suspension page by page, temporary suspension document by document, and setting change in various units.

What is claimed is:

1. A print control device that executes a plurality of filtering units sequentially and in parallel to generate print data of a document, comprising:
an acquisition unit that acquires print information that at least includes attribute information related to the attribute of the document on which the filtering units are executed and status information that indicates a status in which the print data are generated, from the respective filtering units; and
a display unit that displays information display areas for the filtering units, arranged in a predetermined direction in order of which filtering unit is executed first, and that displays the attribute information and status information of the print information in the information display area for each filtering unit.

2. The print control device according to claim 1, further comprising:
an instruction unit that provides an instruction for controlling each of the filtering devices; and
a control unit that controls the filtering units on the basis of the instruction provided from the instruction unit.

3. The print control device according to claim 2, wherein the instruction unit further provides an instruction for controlling the filtering units document by document.

4. The print control device according to claim 1, wherein
the attribute information includes identification information of the corresponding document and page information of the corresponding document, and wherein
the display unit displays the identification information and page information of each of the documents, processed in the respective filtering units, in the information display area for a corresponding one of the filtering units.

5. The print control device according to claim 1, wherein the display unit displays the ratio of a processed amount to an amount to be processed in each filtering unit with a progress bar.

6. The print control device according to claim 1, wherein the display unit displays images of the pieces of print data that are sequentially generated in the respective filtering units.

7. The print control device according to claim 1, wherein
the print information acquired by the acquisition unit is held, and wherein
the display unit compares print information acquired subsequently with the held print information and, when the two pieces of print information are different, performs display on the basis of the print information acquired by the acquisition unit.

8. An information display method for a print control device that executes a plurality of filtering units sequentially and in parallel to generate print data of a document, the print control method comprising:
acquiring print information that at least includes attribute information related to the attribute of the document on which the filtering units are executed and status information that indicates a status in which the print data are generated, from the respective filtering units; and
displaying information display areas for the filtering units, arranged in a predetermined direction in order of which filtering unit is executed first, and displaying the attribute information and status information of the print information in the information display area for each filtering unit.

9. A computer-readable storage medium storing an information display program, executable on a computer, for a print control device that executes a plurality of filtering units sequentially and in parallel. to generate print data of a document, the print control program comprising instructions for:
acquiring print information that at least includes attribute information related to the attribute of the document on which the filtering units are executed and status information that indicates a status in which the print data are generated, from the respective filtering units; and
displaying information display areas for the filtering units, arranged in a predetermined direction in order of which filtering unit is executed first, and displaying the attribute information and status information of the print information in the information display area for each filtering unit.
